(19) United States
(12) Patent Application Publication
(10) Pub. No.: US 2024/0121192 A1
(43) Pub. Date: Apr. 11, 2024

(54) WIFI PACKET COALESCING

(71) Applicants: Advanced Micro Devices, Inc., Santa Clara, CA (US); ATI Technologies ULC, Markham (CA)

(72) Inventors: Ashwini Chandrashekhara Holla, Markham (CA); Indrani Paul, Austin, TX (US); Alexander J. Branover, Boxborough, MA (US); Carlos Javier Moreira, Markham (CA)

(73) Assignees: Advanced Micro Devices, Inc., Santa Clara, CA (US); ATI Technologies ULC, Markham, ON (CA)

(21) Appl. No.: 18/194,311

(22) Filed: Mar. 31, 2023

Related U.S. Application Data
(60) Provisional application No. 63/414,444, filed on Oct. 7, 2022.

(51) Int. Cl. H04L 47/125; H04L 47/11

(52) U.S. Cl. CPC H04L 47/125; H04L 47/11

(57) ABSTRACT

The disclosed device for packet coalescing includes detecting a trigger condition for initiating packet coalescing of packet traffic and sending, to an endpoint device, a notification to start packet coalescing. The device can observe a status in response to starting the packet coalescing and report a performance of the packet coalescing. A system can include a controller that detects a trigger condition for packet coalescing and notifies an endpoint device via a notification register. The controller can read a status register to report, based on the read status, a packet coalescing performance. Various other methods, systems, and computer-readable media are also disclosed.

### CROSS REFERENCE TO RELATED APPLICATION

This application claims the benefit of U.S. Provisional Application No. 63/414,444, filed 7 Oct. 2022, the disclosure of which is incorporated, in its entirety, by this reference.

### BACKGROUND

Computing devices, particularly those running on battery power, often have power management policies to utilize available power resources more efficiently. For example, computing devices can enter low power states, trading off reduced computing performance for reduced power consumption. The low power states are often entered during idle periods when activity (e.g., input/output (I/O) activity) is low so as not to negatively impact a user experience. The low power states can be interrupted and end automatically in response to activity. However, some types of activity, such as WIFI packet activities (e.g., WIFI network traffic/activities), can be sporadic in nature such that the low power states are not effectively utilized.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for WIFI packet coalescing.

FIGS. 2A-B are diagrams relating packet activity to low power states.

FIG. 3 is a diagram of components for an exemplary handshake between a power management module and an endpoint device.

FIG. 4 is a flow diagram of an exemplary method for WIFI packet coalescing.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to WIFI packet coalescing. As will be explained in greater detail below, implementations of the present disclosure determine when entering a low power state is desirable and initiate packet coalescing to better maintain the low power state. By doing so, the systems and methods described herein can improve the functioning of a computer itself by more efficiently managing packet activity, which can in turn reduce the overall power consumption of the device and improve power management.

As will be described in greater detail below, the instant disclosure describes various systems and methods for WIFI packet coalescing by determining a desirable time for increasing low power state duration and instructing an endpoint device that receives packets to begin packet coalescing.

In one example, a device for WIFI packet coalescing includes a controller configured to (i) detect a trigger condition for packet coalescing of packet traffic, (ii) send, to an endpoint device, a notification to initiate packet coalescing, and (iii) observe a status in response to initiating the packet coalescing. In some examples, the controller is also configured to report, based on the observed status, a packet coalescing performance.

In some examples, the trigger condition corresponds to a power management policy. In some examples, the power management policy corresponds to at least one of a low power mode or a battery power mode (e.g., a direct current mode). In some examples, the power management policy corresponds to a power consumption based on a current workload. In some examples, the power management policy corresponds to a low input/output (I/O) activity.

In some examples, the notification includes a type of packet traffic to coalesce. In some examples, the type of packet traffic corresponds to bulk traffic. In some examples, the type of packet traffic corresponds to isochronous traffic.

In some examples, the controller is configured to send the notification to the endpoint device via a register. In some examples, the endpoint device stores the status in a register. In some examples, the status corresponds to an observed idle duration. In some examples, the controller is further configured to send feedback to the endpoint device based on the status.

In some examples, the observed idle duration corresponds to an amount of time the endpoint device has stored packets in a buffer of the endpoint device. In some examples, the controller is further configured to report the packet coalescing performance by analyzing whether the observed idle duration achieved a desired idle duration. In some examples, the controller is further configured to report the packet coalescing performance to the endpoint device to provide feedback on the packet coalescing.

In one implementation, a system for WIFI packet coalescing includes a notification register, a status register, and a controller configured to (i) detect a trigger condition for packet coalescing of packet traffic, (ii) store, in the notification register, a notification to initiate packet coalescing, and (iii) observe, from the status register, a status in response to initiating the packet coalescing. In some examples, the controller is also configured to report, based on the observed status, a packet coalescing performance.

In some examples, the trigger condition corresponds to at least one of a power management policy, a low power mode, a battery power mode, a power consumption based on a current workload, or a low input/output (I/O) activity. In some examples, the notification includes a type of packet traffic to coalesce. In some examples, the status corresponds to an idle duration.

In some examples, the status corresponds to an observed idle duration corresponding to an amount of time the endpoint device has stored packets in a buffer of the endpoint device. In some examples, the controller is further configured to report the packet coalescing performance by analyzing whether the observed idle duration achieved a desired idle duration. In some examples, the controller is further configured to report the packet coalescing performance via the notification register to provide feedback on the packet coalescing.

In one implementation, a method for WIFI packet coalescing includes (i) detecting a trigger condition, corresponding to a power management policy, for packet coalescing of packet traffic, (ii) sending, to an endpoint device via a notification register, a notification to initiate packet coalescing a type of packet traffic, and (iii) observing, via a status register, an idle duration of the endpoint device in response to initiating the packet coalescing. In some examples, the method also includes reporting, based on the observed idle duration, a packet coalescing performance.

In some examples, the power management policy further corresponds to at least one of a low power mode, a battery power mode, a power consumption based on a current workload, or a low input/output (I/O) activity.

In some examples, the type of packet traffic corresponds to at least one of bulk traffic or isochronous traffic. In some examples, the method further includes analyzing the idle duration and sending feedback to the endpoint device based on analyzing the idle duration.

In some examples, the observed idle duration corresponds to an amount of time the endpoint device has stored packets in a buffer of the endpoint device. In some examples, reporting the packet coalescing performance includes analyzing whether the observed idle duration achieved a desired idle duration. In some examples, reporting the packet coalescing performance further comprises providing, via the notification register, feedback on the packet coalescing.

Features from any of the implementations described herein can be used in combination with one another in accordance with the general principles described herein. These and other implementations, features, and advantages will be more fully understood upon reading the following detailed description in conjunction with the accompanying drawings and claims.

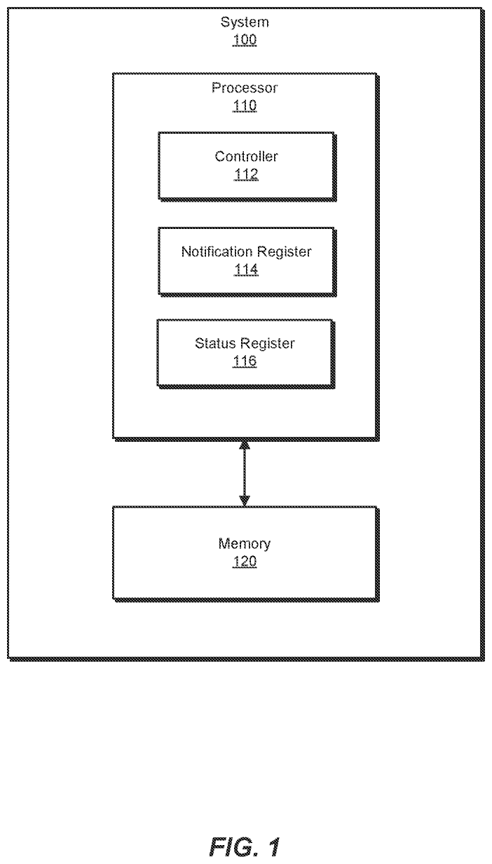

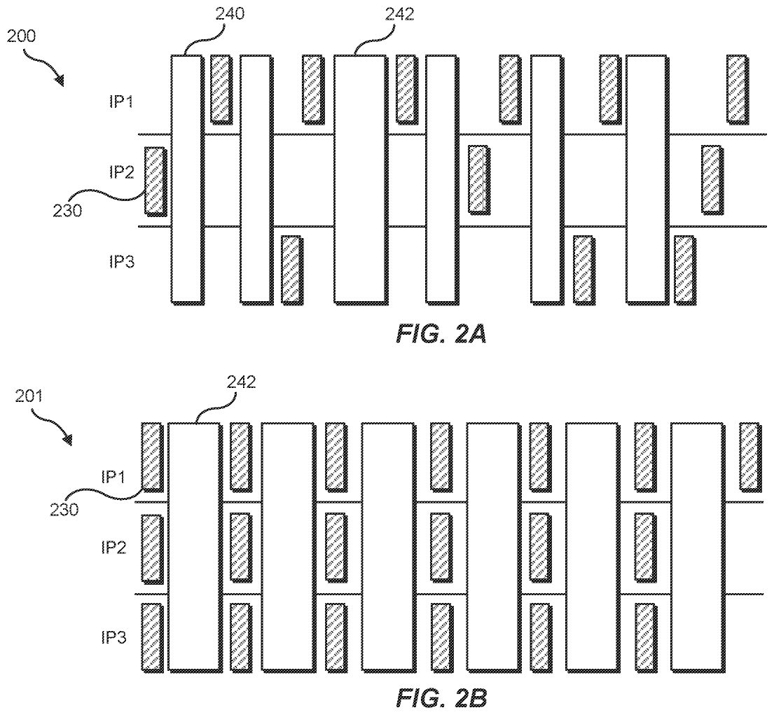

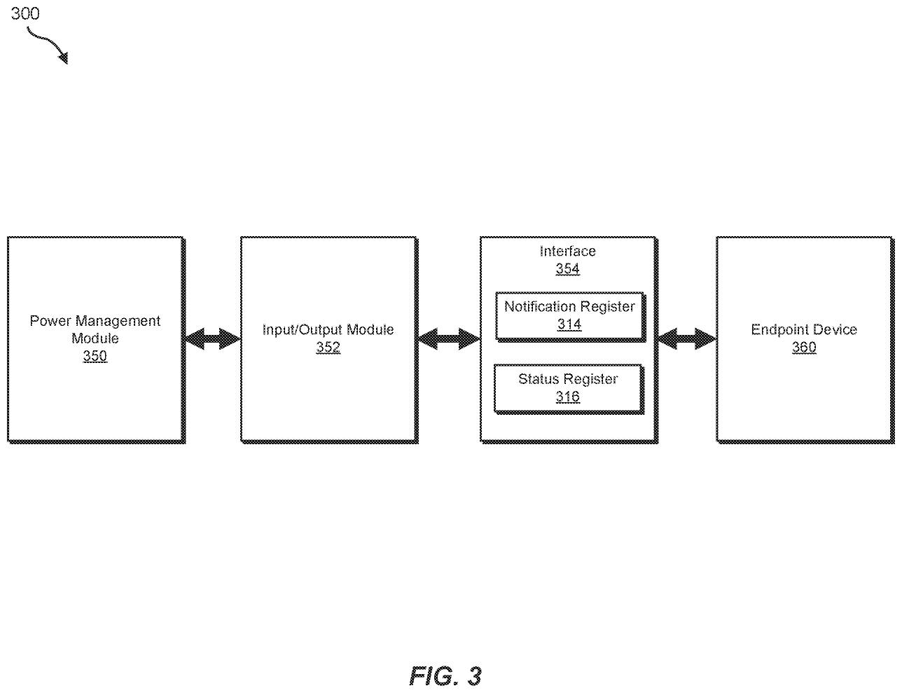

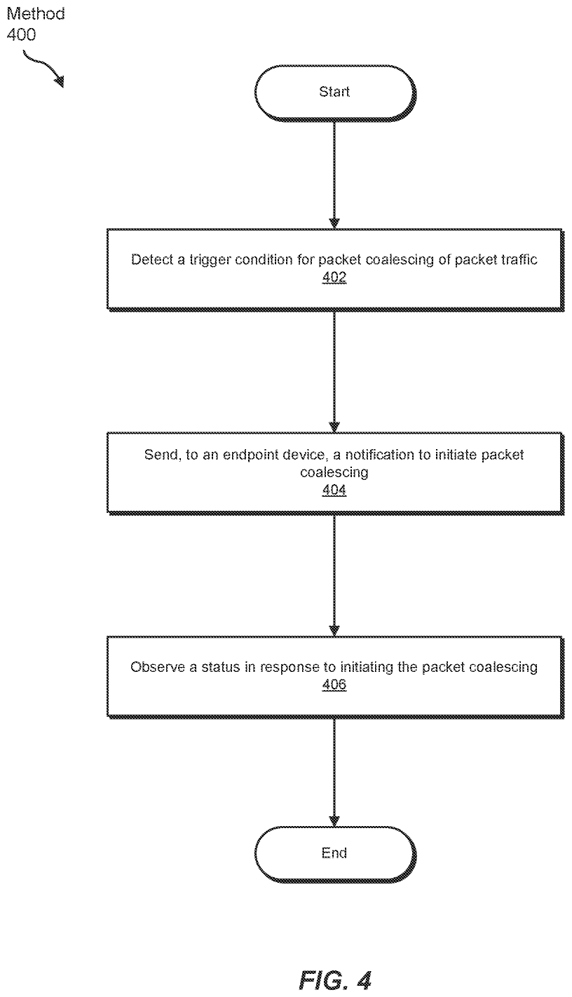

The following will provide, with reference to FIGS. 1-4, detailed descriptions of WIFI packet coalescing. Detailed descriptions of an example system will be provided in connection with FIG. 1. Detailed descriptions of packet activity as it relates to low power states will be provided in connection with FIGS. 2A-2B. Detailed descriptions of components for an exemplary handshake between a power management module and an endpoint device will be provided in connection with FIG. 3. Detailed descriptions of corresponding computer-implemented methods will also be provided in connection with FIG. 4.

FIG. 1 is a block diagram of an example system 100 for packet coalescing. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

As further illustrated in FIG. 1, processor 110 includes a controller 112, a notification register 114, and a status register 116. Controller 112 corresponds to a control circuit and includes circuitry and/or instructions (e.g., firmware and/or software) for device power management. Notification register 114 corresponds to a public/visible local storage that can be used for communication, e.g., by storing notifications readable by a recipient device. Status register 116 corresponds to a public/visible local storage that can be used for storing a status report, as will be described further below.

FIGS. 2A-2B illustrate diagrams of WIFI packet activity of a computing device such as system 100. The computing device can have an endpoint device (e.g., a WIFI transmitter/receiver and/or other network interface device) that sends and receives data packets for a communication protocol such as WIFI. FIG. 2A illustrates a diagram 200 of packet activity and FIG. 2B illustrates a diagram 201 of coalesced packet activity across three internet protocol (IP) channels, although in other implementations can correspond to interrupt channels.

During an idle period (e.g., a duration of time with low activity), the computing device can enter a low power state 240 in which the device's power consumption is reduced. During a sufficiently long idle period, the device can also enter a deep low power state 242 in which the device's power consumption is further reduced. However, a packet 230 can interrupt the low power states and can force the device to wake up and process packet 230. As illustrated in FIG. 2A, packets 230 can be received sporadically across IP1, IP2, and IP3. When all three channels are quiet, the device can enter a low power state. Receiving a packet along any channel will interrupt the low power state. Therefore, as shown in FIG. 2A, the device can have difficulty being idle long enough to enter deep low power state 242.

FIG. 2B illustrates how packet coalescing allows more consistent idle periods. By instructing the endpoint device to coalesce packets, the endpoint device can buffer received packets and provide the buffered packets at more regular intervals (e.g., in bursts rather than spread out). As shown in FIG. 2B, the device can more regularly and reliably enter deep low power state 242 because a sporadic packet is less likely to interrupt an idle period.

Although FIGS. 2A and 2B and the examples described herein refer to WIFI packets, in other examples, the packets can correspond to other communication protocols. In addition, although FIGS. 2A and 2B describe low power state 240 and deep low power state 242, in other examples a device's power management can include various other types of low power states.

FIG. 3 illustrates an exemplary path between a power management module and an endpoint device. FIG. 3 illustrates a device 300 which corresponds to system 100. Device 300 includes a power management module 350, which in some examples corresponds to controller 112, an input/output (I/O) module 352, an interface 354, and an endpoint device 360. Power management module 350 represents circuitry and/or software (e.g., firmware) for managing power consumption of device 300 such as through power management policies. I/O module 352 represents circuitry and/or software (e.g., firmware) for communicating with input devices. Interface 354 represents circuitry and/or software (e.g., firmware) for communications between the various components of device 300. Endpoint device 360 represents circuitry and/or software (e.g., firmware) for interfacing/communicating with external devices, which in some implementations corresponds to network communications (e.g., WIFI).

To avoid using a driver or processor interaction for communicating between power management module 350 and endpoint device 360, in some implementations registers in interface 354 can be used to store messages. For example, interface 354 can have a notification register 314 (corresponding to notification register 114) and a status register 316 (corresponding to status register 116). Notification register 314 and/or status register 316 can be public/visible to power management module 350 and endpoint device 360.

Power management module 350 can determine, for instance based on a power management policy, when enabling packet coalescing is desirable. For example, when device 300 is on battery power (e.g., a direct current (DC) mode and/or a battery saver mode), a reduced power consumption is desirable. Other criteria for desiring reduced power consumption include a reduced need for power consumption for a current workload, low I/O activity, etc. To notify endpoint device 360 to initiate packet coalescing, power management module 350 can store a notification in notification register 314 for endpoint device 360.

In some implementations, the notification can include additional instructions. For example, the notification can indicate what type of packet traffic to coalesce, such as bulk traffic, isochronous traffic (e.g., traffic that is delivered with time constraints such as to ensure audio is synchronized with video), etc. Further, in some examples, the notification can indicate a desired buffering. For instance, the desired buffering can correspond to a time period (e.g., 2 ms) or a total number and/or size of packets to buffer.

Endpoint device 360 can read the notification from notification register 314 and perform packet coalescing by buffering received packets. Although endpoint device 360 can attempt to adhere to the instructions provided in the notification, in some implementations, endpoint device 360 can deviate from the instructions. For instance, endpoint device 360 can choose not to buffer a packet that is considered high priority or time sensitive.

To gauge buffer performance, endpoint device 360 can store a status report in status register 316. For example, the status report can indicate an idle duration (e.g., an average idle duration, minimum idle duration, etc.) achieved through the buffering. In some examples, if the buffering was not effective, the minimum idle duration can be 0 ms.

Moreover, in some implementations, power management module 350 can analyze the status report. For example, power management module 350 can determine a performance of the provided instructions and provide feedback (e.g., a new notification) to endpoint device 360 to improve a buffering scheme. In some examples, power management module 350 can dynamically manage packet coalescing.

FIG. 4 is a flow diagram of an exemplary computer-implemented method 400 for WIFI packet coalescing. The steps shown in FIG. 4 can be performed by any suitable computer-executable code and/or computing system, including the system(s) illustrated in FIGS. 1 and/or 3. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein detect a trigger condition for packet coalescing of packet traffic. For example, controller 112 and/or power management module 350 detects one or more trigger conditions for packet coalescing of packet traffic.

The systems described herein can perform step 402 in a variety of ways. In one example, the trigger condition corresponds to a power management policy. For example, the power management policy corresponds to at least one of a low power mode, a battery power mode (e.g., a direct current mode and/or a battery saver mode). In some examples, the power management policy corresponds to a power consumption based on a current workload and/or a low input/output (I/O) activity.

In addition, in some examples the notification includes a type of packet traffic to coalesce. The type of packet traffic can correspond to bulk traffic, isochronous traffic, and/or other types of traffic.

At step 404 one or more of the systems described herein send, to an endpoint device, a notification to initiate packet coalescing. For example, controller 112 and/or power management module 350 sends (e.g., to endpoint device 360) a notification to initiate packet coalescing.

The systems described herein can perform step 404 in a variety of ways. In one example, the notification is sent to the endpoint device via a register, such as notification register 114 and/or notification register 314.

In some implementations, the notification can include additional information and/or instructions for the endpoint device. For example, a desired idle duration of the traffic coalescing can be communicated to the endpoint device. The endpoint device can resume traffic after the desired idle duration elapses. In some examples, the endpoint device can resume traffic sooner (e.g., before the desired idle duration elapses) based on internal indications, such as buffer status (e.g., the buffer is full and should be flushed), response timers, etc. Thus, the endpoint device can resume traffic based on the desired idle duration elapsing or internal indications, whichever occurs first.

At step 406 one or more of the systems described herein observe a status in response to initiating the packet coalescing. For example, controller 112 and/or power management module 350 observes a status report (e.g., provided by endpoint device 360) in response to initiating the packet coalescing.

The systems described herein can perform step 406 in a variety of ways. In one example, the endpoint device stores the status in a register, such as status register 116 and/or status register 316 for controller 112 and/or power management module 350 to read. In some examples, the status corresponds to an observed idle duration. In some examples, the observed idle duration can correspond to a buffer performance of the endpoint device, for instance an amount of time the endpoint device has stored packets in the buffer.

Further, in some implementation, one or more of the systems described herein report, based on the observed status, a packet coalescing performance. For example, controller 112 and/or power management module 350 reports a packet coalescing performance of the endpoint device.

In one example, controller 112 and/or power management module 350 can analyze the observed status report to determine whether the observed idle duration achieved the desired idle duration, which can indicate whether the packet coalescing was successful. In some examples, the analysis can include determining the packet coalescing performance in response to the initial notification, such as an effectiveness of the notification, whether any additional information provided in the notification affected packet coalescing performance, etc. In some examples, the analysis can be used for updating the desired idle duration.

In some implementations, controller 112 and/or power management module 350 can report the packet coalescing performance internally (e.g., using the analysis to modify trigger conditions and/or notifications). In some implementations, controller 112 and/or power management module 350 can report (e.g., via a notification and/or notification register 114) the packet coalescing performance to the endpoint device, such as by sending feedback to the endpoint device on the packet coalescing. For instance, controller 112 and/or power management module 350 can send feedback (e.g., via a new notification) to endpoint device 360 for improving the packet coalescing performance. In some examples, the new notification can also include instructions for follow up actions, such as another packet coalescing in response to the packet coalescing performance (e.g., updated instructions for packet coalescing).

As detailed above, the present disclosure is directed to WIFI packet coalescing for improved power management. A power management firmware of an SOC can send a message to an endpoint device to enable packet coalescing, such that the endpoint device buffers received packets. In one implementation, the message is sent through various components to reach the endpoint device. Once the packet coalescing feature is enabled, the endpoint device buffers packets and reports, in a status register readable by the SOC, a time duration of packet buffering, which corresponds to idle duration. The SOC can perform further analysis of idle duration times. For example, to achieve an improved residency in deep sleep states, especially for battery life use cases such as video conferencing, a sufficient idle duration (e.g., about 5 ms) in a frame window can be used.

WIFI traffic can be spread out, which can keep an SOC awake and further prevent the SOC from going into deep sleep states. Therefore, the packet coalescing feature described herein can be used to increase the burstiness of the WIFI traffic.

In one example for the packet coalescing feature an IO firmware can send a message to the endpoint device through an interface private config space. This message does not necessarily involve any driver or CPU interactions. It can convey information such as enabling/disabling the feature and a notification to start packet coalescing. Use cases of interest include DC mode, operation in lowest operational power state, etc. These may be slow moving or infrequent events. The message can also indicate what type of traffic can be coalesced (e.g., bulk traffic vs. iso traffic).

The endpoint device reports a status on the minimum idle duration observed by the device in an interface's visible register. The status register can also have the time corresponding to no activity coming out of the device. For example, if packet coalescing was not successful, then the minimum idle duration may be zero. It may be desirable for the endpoint device to allocate sufficient buffer to achieve 5 ms idle duration.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

Although illustrated as separate elements, the modules described and/or illustrated herein can represent portions of a single module or application. In addition, in certain implementations one or more of these modules can represent one or more software applications or programs that, when executed by a computing device, cause the computing device to perform one or more tasks. For example, one or more of the modules described and/or illustrated herein represent modules stored and configured to run on one or more of the computing devices or systems described and/or illustrated herein. In some implementations, a module can be implemented as a circuit or circuitry. One or more of these modules can also represent all or portions of one or more special-purpose computers configured to perform one or more tasks.

In addition, one or more of the modules described herein transforms data, physical devices, and/or representations of physical devices from one form to another. For example, one or more of the modules recited herein receives workload data to be transformed, transforms the data, outputs a result of the transformation to initiate packet coalescing, uses the result of the transformation to analyze performance, and stores the result of the transformation to further instruct an endpoint device. Additionally or alternatively, one or more of the modules recited herein can transform a processor, volatile memory, non-volatile memory, and/or any other portion of a physical computing device from one form to another by executing on the computing device, storing data on the computing device, and/or otherwise interacting with the computing device.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a controller configured to:
detect a trigger condition for packet coalescing of packet traffic;
send, to an endpoint device, a notification to initiate packet coalescing; and
observe a status in response to initiating the packet coalescing.

2. The device of claim 1, wherein the trigger condition corresponds to a power management policy.

3. The device of claim 2, wherein the power management policy corresponds to at least one of a low power mode, a battery power mode, a power consumption based on a current workload, or a low input/output (I/O) activity.

4. The device of claim 1, wherein the controller is further configured to report, based on the observed status, a packet coalescing performance.

5. The device of claim 4, wherein the status corresponds to an observed idle duration.

6. The device of claim 5, wherein the observed idle duration corresponds to an amount of time the endpoint device has stored packets in a buffer of the endpoint device.

7. The device of claim 5, wherein the controller is further configured to report the packet coalescing performance by analyzing whether the observed idle duration achieved a desired idle duration.

8. The device of claim 4, wherein the controller is further configured to report the packet coalescing performance to the endpoint device to provide feedback on the packet coalescing.

9. The device of claim 1, wherein the notification includes a type of packet traffic to coalesce.

10. The device of claim 9, wherein the type of packet traffic corresponds to bulk traffic or isochronous traffic.

11. The device of claim 1, wherein the controller is configured to send the notification to the endpoint device via a register.

12. The device of claim 1, wherein the endpoint device stores the status in a register.

13. A system comprising:
a notification register;
a status register; and
a controller configured to:
detect a trigger condition for packet coalescing of packet traffic;
store, in the notification register, a notification to initiate packet coalescing; and
observe, from the status register, a status in response to initiating the packet coalescing.

14. The system of claim 13, wherein the status corresponds to an observed idle duration corresponding to an amount of time an endpoint device has stored packets in a buffer of the endpoint device.

15. The system of claim 14, wherein the controller is further configured to report, based on the observed status, a packet coalescing performance by analyzing whether the observed idle duration achieved a desired idle duration.

16. The system of claim 13, wherein the controller is further configured to report, based on the observed status, a packet coalescing performance via the notification register to provide feedback on the packet coalescing.

17. A method comprising:
detecting a trigger condition, corresponding to a power management policy, for packet coalescing of packet traffic;
sending, to an endpoint device via a notification register, a notification to initiate packet coalescing a type of packet traffic; and
observing, via a status register, an observed idle duration of the endpoint device in response to initiating the packet coalescing.

18. The method of claim 17, further comprising reporting, based on the observed idle duration, a packet coalescing performance, wherein the observed idle duration corresponds to an amount of time the endpoint device has stored packets in a buffer of the endpoint device.

19. The method of claim 18, wherein reporting the packet coalescing performance includes analyzing whether the observed idle duration achieved a desired idle duration.

20. The method of claim 18, wherein reporting the packet coalescing performance further comprises providing, via the notification register, feedback on the packet coalescing.
